(19) United States
(12) Patent Application Publication
(10) Pub. No.: US 2017/0159835 A1
(43) Pub. Date: Jun. 8, 2017

(54) PRESSURE LIMITING VALVE

(71) Applicant: Delphi International Operations Luxembourg S.A.R.L., Bascharage (LU)

(72) Inventors: Raphael Rouillon, Onzain (FR); Guillaume Trenado, Les Montils (FR); Jerome Simon, Vineuil (FR)

(21) Appl. No.: 15/323,639

(22) PCT Filed: Jun. 23, 2015
(86) PCT No.: PCT/EP2015/064072

§ 371 Date: Jan. 3, 2017

(30) Foreign Application Priority Data
Jul. 3, 2014 (GB) 1411856.6

(51) Int. Cl. F16K 17/04; F02M 61/18; G05D 16/10

(52) U.S. Cl. CPC F16K 17/0406; G05D 16/103; F02M 61/188; F02M 61/1886

(57) ABSTRACT

A pressure limiting valve communicates between a closed state, where a ball is biased against a valve seat along a contacting line and, an open state, where the ball is at a distance of the valve seat enabling fluid under pressure to exit via a relief orifice opening in the valve seat. The valve seat is shaped so that in the closed state of the valve, the contacting line between the ball and the valve seat is at a distance from the relief orifice opening.

### CROSS REFERENCE TO RELATED APPLICATIONS

This application is a national stage application under 35 USC 371 of PCT Application No. PCT/EP2015/064072 having an international filing date of Jun. 23, 2015, which is designated in the United States and which claimed the benefit of GB Patent Application No. 1411856.6 filed on Jul. 3, 2014 the entire disclosures of each are hereby incorporated by reference in their entirety.

### TECHNICAL FIELD

The present invention relates to a pressure limiting valve especially of the type used in fuel injection equipment's.

### BACKGROUND OF THE INVENTION

A pressure limiting valve is a safety equipment arranged on a high pressure device for limiting to a predetermined threshold the pressure inside the device. In fuel injection equipment such a valve cooperates with a common rail that delivers high pressure fuel to a plurality of fuel injectors. The valve commutes between an open state enabling fuel exit from the rail and, a closed state where said exit is prevented.

The valve comprises a ball biased by a spring against a valve seat at the center of which opens a relief orifice. When the pressure inside the rail is below a predetermined threshold the ball closes the orifice and, when the pressure increases over said threshold the fuel inside the rail generates on the ball an opening force exceeding the closing force of the spring and pushing the ball away from the seat, opening a passage and enabling exit of a flow of fuel.

Structurally the valve comprises a housing provided with a bore that is blind at one extremity and provided at the opposite extremity with a seating member centrally holed by a relief orifice. Inside the housing are arranged the compression spring and a sliding piston that cooperates with the ball push said ball against the valve seat. The valve seat is a concave spherical recess at the center of which opens the relief orifice. The diameter of said spherical seat is a little bigger than the diameter of the ball so that, in closed state the ball can be biased at the bottom of the seat and closes the orifice by being in sealing contact against the edge of the opening of the relief orifice and, in open state, the ball lifts up from the seat and provides to the exiting fuel a restricted passage between the spherical wall of the seat and the ball. Opposite to the valve seat, the ball is in permanent contact against the piston that is provided with another recess aiming at maintaining the ball in place.

The displacements between the closed and the open states are small and experience has shown that the ball, when closing, does not always perfectly position over the relief orifice. Indeed, the ball may set in a position slightly on the side of the orifice and, in time non-symmetrical wear occurs and perfect sealing of the relief orifice, as expected in closed state, may not be ensured enabling minor leaks.

### SUMMARY OF THE INVENTION

Accordingly, it is an object of the present invention to resolve, at least partially, the above mentioned problems in providing a pressure limiting valve adapted to commute between a closed state, where a ball is biased against a valve seat along a contacting line and, an open state, where the ball is at a distance of the valve seat enabling fluid under pressure to exit via a relief orifice opening in the valve seat. Advantageously the valve seat is shaped so that in closed state of the valve, the contacting line between the ball and the valve seat is at a distance from the opening of the relief orifice. Consequently the ball correctly repositions when closing and sealing the relief orifice.

The portion of the wall of the valve seat that is downstream the contacting line is substantially parallel to the surface of the ball when it is in open state and, consequently the pressure of the fluid exiting the relief orifice and flowing in the passage between the ball and the valve seat decrease slowly.

The valve seat comprises a conical face where, in the closed state, is the contacting line with the ball.

The opening of the relief orifice and the valve seat define a common edge, the contacting line being distant from said edge.

The valve seat further comprises a spherical portion defining with the conical portion another circular edge, larger than said common edge. The spherical portion is substantially parallel to the surface of the ball so that the fluid exiting the relief orifice is maintained under pressure.

The valve is particularly adapted to be used in fuel injection equipment.

The invention further extends to a fuel injection equipment of an internal combustion engine, said equipment being provided with a pressure limiting valve as set in any of the preceding claims.

### BRIEF DESCRIPTION OF THE DRAWINGS

The present invention is now described by way of example with reference to the accompanying drawings in which:

FIG. 1 is an axial section of a pressure limiting valve as per the invention.

FIG. 2 is an axial section of the seat of the valve of FIG. 1.

FIG. 3 is a top view of the ball seat of FIG. 2.

FIG. 4 is magnified detail of the ball in closed state.

FIG. 5 is similar to FIG. 4 with the ball being in open state.

### DESCRIPTION OF THE PREFERRED EMBODIMENTS

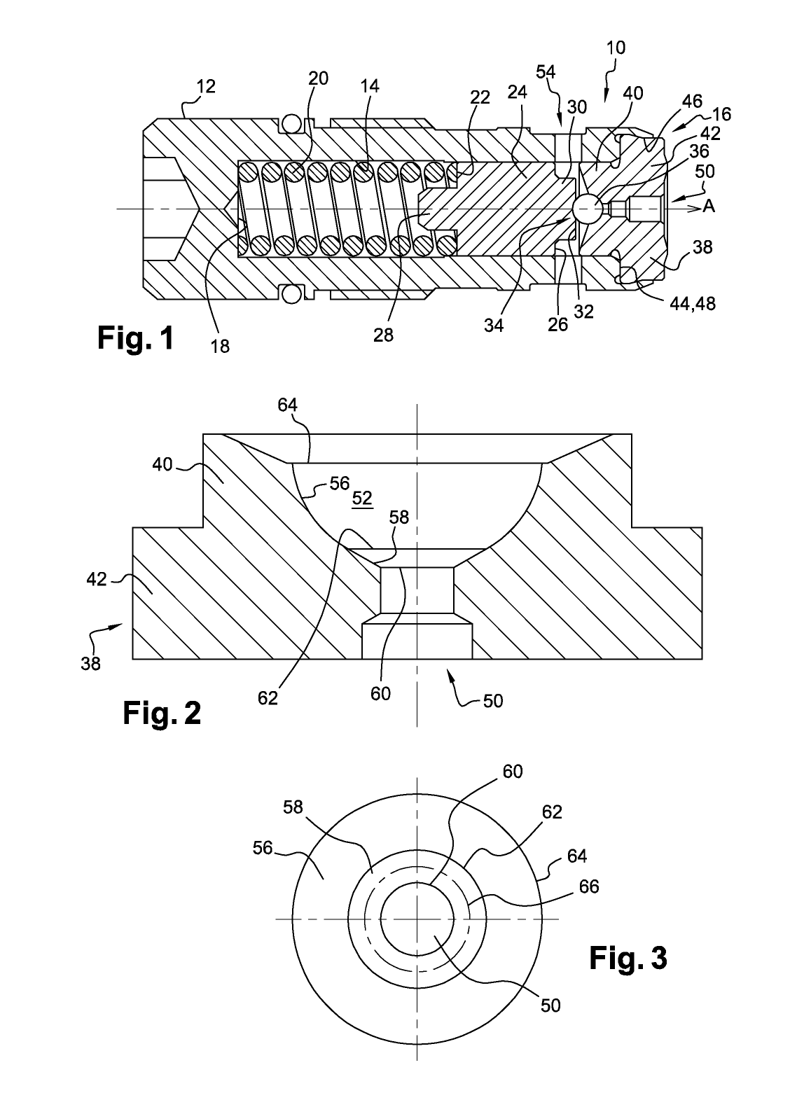

A pressure limiting valve 10 is described in reference to FIG. 1. The valve 10 is a mechanical valve although the invention is also applicable to electro-valves. A first usage of the valve 10 is to be arranged in a fuel injection equipment 8.

The valve 10 comprises a housing 12 provided with a central bore 14 extending along a longitudinal axis A from an opening 16, on the right of the housing 12 as per the orientation of the figure, to a blind end 18, on the left of the figure. Inside the bore 14, a spring 20 is compressed between the blind end 18 and the back face 22 of a piston 24 that is slidably arranged in the bore 14. The piston 24 is cylindrical and axially A extends from the back face 22 to a front face 26.

The back face 22 is centrally provided with a cylindrical protrusion 28 around which wind the last turns of the spring 20 and, the front face 26 is also axially A provided with a central cylindrical protrusion 30, the top face 32 of said front protrusion 30 being provided with a small spherical concave recess 34 in which is placed a ball 36. The opening 16 of the bore 14 is closed by a seating member 38 which comprises an inner cylindrical portion 40 and an outer larger cylindrical portion 42, a transversal disc face 44 joining the two portions.

By the opening 16 of the bore 14, the housing 12 is provided with a cylindrical recess 46 defining a transversal disc face 48. The seating member 38 is arranged so that its inner portion 40 complementary engages in the bore 14 and the outer portion 42 positions in the cylindrical recess 46, the disc face 44 of the seating member 38 abutting against the disc face 48 of the housing 12. As visible on FIG. 1, the wall of the housing 12 is thinner around the recess 46 and the seating member 38 is therein fixedly crimped.

The seating member 38 is axially provided with a through hole 50 that is a pressure relief orifice 50 which opens inside the valve 10 where it defines a concave seating face 52 surrounding the orifice 50, the ball 36 being biased against the seating face 52.

The valve 10 is further provided with a radial outlet hole 54 extending through the wall of the housing 12 and arranged in the vicinity of the seating member 38.

Externally, the housing 12 is further provided with a thread and an 0-ring seal for complementary sealing engagement with a female thread and fixing onto a reservoir, not represented, such as the rail of a fuel injection equipment. On its very back face, the housing is externally provided with a hexagonal recess for complementary engagement of a tool enabling to screw the valve 10 onto said reservoir. Multiple alternatives are known for constructing a pressure limiting valve and the above description provides a non-limiting example.

Prior to further detailed description, the operation of the valve 10 is now briefly explained.

The valve 10, chosen as example, is adapted to be arranged at the end of the common rail of fuel injection equipment. In the rail, the fuel is at high pressure and it generates on the ball 36 an opening force tending to push the ball away from the seating face 52. The spring 20 generates a counter closing force transmitted by the piston 24 to the ball 36. As long as the pressure inside the rail does not reach a predetermined threshold, the closing force of the spring 20 biases the ball 36 against the seating face 52 and seals the orifice 50. When the pressure inside the rail reaches said threshold, the opening force surpasses the closing force and the fuel pushes the ball 36 at a distance from the seating face 52. The fuel under pressure is then able to exit the rail via the relief orifice 50 and flows around the ball 36 to exit the valve 10 via the outlet hole 50 which is connected to a return low pressure drain. As the fuel exits the rail the pressure inside the rail decreases and, as soon as said pressure falls below the threshold the ball 36 is once again biased on the seating face 52.

To ensure that over time and after multiple openings and closings, the ball 36 continues to correctly seal the orifice 50, the seating face 52 is now more precisely described in reference to the FIGS. 2, 3 and 4.

The concave seating face 52 comprises two distinct portions: a spherical surface 56 and a conical surface 58. The relief orifice 50 opens at the bottom of the seating face 52 where it merges with the conical surface 58 defining a first circular edge 60. The conical surface 58 axially extends and widens until it merges, almost tangentially, with the spherical surface 56, still defining a second circular edge 62. The spherical surface 56 has a diameter slightly larger than the diameter of the ball 36 and said spherical surface 56 extends from said second edge 62 to a third edge 64 where the seating face 52 suddenly largely widens.

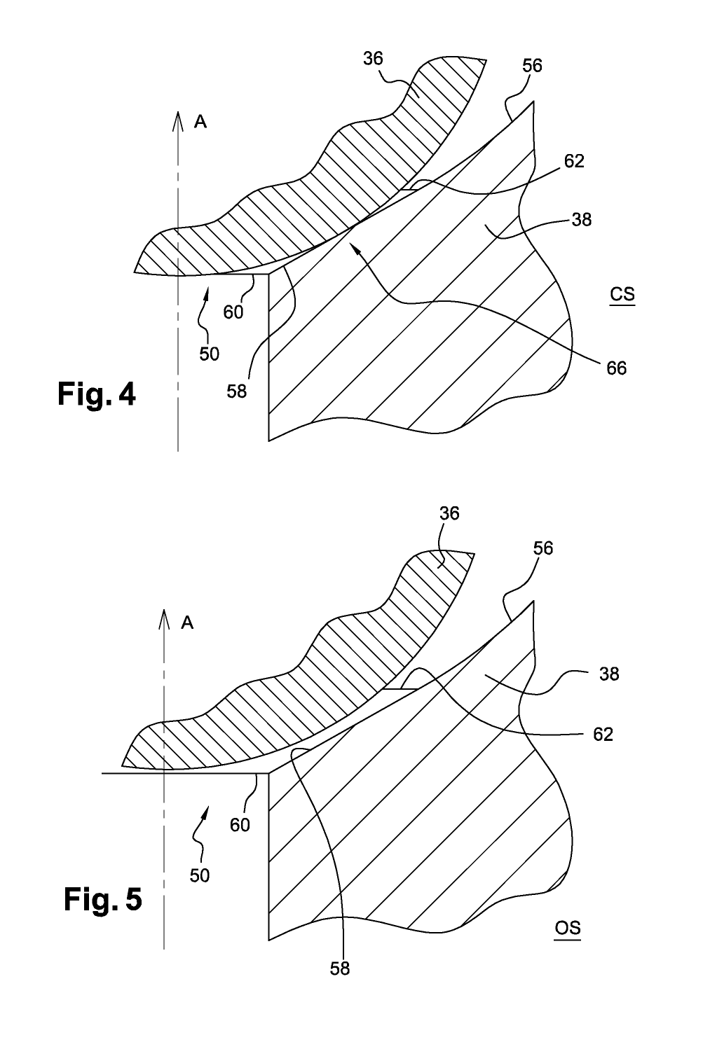

As it is magnified on FIG. 4, when in a closed state CS, the ball 36 abuts on the conical surface 58 along a closed circular contacting line 66, which is away from both first 60 and second 62 edges.

When in an open state OS, as magnified on FIG. 5, the ball 36 has axially moved away from the conical surface 58 opening a passage for the fuel exiting from the relief orifice 50. Upstream the contacting line 66, the section of said passage slowly increases until the third edge 64 upstream of which the passage largely increases.

With such arrangement, in the closed state CS, the ball 36 is always biased against the conical surface 58 defining a closed contacting line 66 ensuring sealing of the relief orifice.

The following list of references has been utilized in this description:
8 fuel injection equipment
10 pressure limiting valve
12 housing of the valve
14 central bore
16 opening of the bore
18 blind end of the bore
20 spring
22 back face of the piston
24 piston
26 front face of the piston
28 cylindrical protrusion on the back face
30 cylindrical protrusion on the front face
32 top face of the front protrusion
34 concave recess
36 ball
38 seating member
40 inner portion of the seating member
42 outer portion of the seating member
44 disc face of the seating member
46 cylindrical recess in the housing
48 transversal disc face of the housing
50 pressure relief orifice
52 concave seating area in the seating member
54 radial outlet hole
56 spherical surface
58 conical surface
60 first edge
62 second edge
64 third edge
66 contacting line
A Longitudinal axis
OS open state
CS closed state

1-6. (canceled)

7. A pressure limiting valve which commutes between a closed state and an open state, the pressure limiting valve comprising:
a ball; and
a valve seat, wherein in the closed state the ball is biased against the valve seat along a contacting line and wherein in the open state the ball is at a distance from the valve seat enabling fluid under pressure to exit via a relief orifice opening in the valve seat;
wherein the valve seat is shaped so that in the closed state, the contacting line between the ball and the valve seat is at a distance from the opening of the relief orifice and wherein a portion of the valve seat that is downstream of the contacting line is substantially parallel to the surface of the ball when said ball is in the open state so that the pressure of the fluid exiting the relief orifice opening and flowing between the ball and the valve seat decreases slowly.

8. A pressure limiting valve as set in claim 7 wherein the valve seat comprises a conical face where is the contacting line.

9. A pressure limiting valve as set in claim 8 wherein the relief orifice opening and the valve seat define a common edge, the contacting line being distant from said common edge.

10. A pressure limiting valve as set in claim 9 wherein the valve seat further comprises a spherical portion defining with the conical portion a circular edge, larger than said common edge, said spherical portion being substantially parallel to the surface of the ball so that the fluid exiting the relief orifice opening is maintained under pressure.

11. A pressure limiting valve as set in claim 7 adapted to be used in fuel injection equipment.

12. Fuel injection equipment of an internal combustion engine, said fuel injection equipment being provided with a pressure limiting valve as set in claim 7.
